(19) United States
(12) Patent Application Publication
(10) Pub. No.: US 2004/0180180 A1
(43) Pub. Date: Sep. 16, 2004

(54) Perfectly waterproofed printing and copying sheet

(76) Inventor: Shin Nakashima, Nara-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/773,279

(22) Filed: Feb. 9, 2004

(30) Foreign Application Priority Data
Mar. 14, 2003 (JP) 2003-70742
Apr. 28, 2003 (JP) 2003-123940

(51) Int. Cl. B32B 3/00

(52) U.S. Cl. 428/195.1

(57) ABSTRACT

A perfectly waterproofed printing and copying sheet according to the present invention comprises a sheet of paper having high degree water-resisting property which has a front surface dry-laminated with a colorless transparent film of water-resisting heat-resisting synthetic resin and a back surface dry-laminated with a colorless transparent film of water-resisting heat-resisting synthetic resin or a back surface coated with a layer of water-resisting adhesives to which a releasing paper is affixed.

In the perfectly waterproofed printing and copying sheet, the front surface, back surface and side surfaces owing to the thickness of the sheet are perfectly waterproofed.

### BACKGROUND OF THE INVENTION

This invention relates to a perfectly waterproofed printing and copying sheet suitable for outdoor advertisements, outdoor notifications, etc. and suitable for bar codes and labels for seafood which is moist and watery.

As to former printing and copying sheets which were used for the above-mentioned purposes, there were a printing and copying sheet comprising a layer of film of water-resisting heat-resisting synthetic resin capable of perfectly waterproofing and a printing and copying sheet comprising a sheet of paper as a base material, a thin film of water-resisting heat-resisting synthetic resin which was laminated on the front surface of the sheet of paper and a thin film of water-resisting heat-resisting synthetic resin or a layer of water-resisting adhesives which was laminated or coated on the back surface of the sheet of paper.

However, the former was expensive, and the latter was easily swelled, because of sides of the printing and copying sheet owing to the thickness of the sheet of paper absorbed moisture and water, and then, the latter curled and waved, when kept in custody. Also, the latter was often blocked in or sent out of printing or copying machines, as two or more than two sheets were superposed, when used by means of the printing or copying machines.

### SUMMARY OF THE INVENTION

Then, for the purpose of preventing sides of the printing and copying sheet from absorbing moisture and water, this inventor used water-resisting paper having high degree water resisting property in place of ordinary paper formerly used, and the inventor succeeded to make whole of the sheet perfectly waterproofed and to reduce the cost. Thus, the inventor completed this invention.

Namely, this invention provides a perfectly waterproofed printing and copying sheet which can be prevented from curling and waving due to moisture or water, when kept in custody, and which can be prevented from being blocked in or sent out of printing or copying machines, as two or more than two sheets are superposed, when used by means of printing or copying machines.

Also, this invention provides a perfectly waterproofed printing and copying sheet which is perfectly waterproofed, and which can reduce the cost sharply.

For the purpose of accomplishing the above-mentioned problems, the perfectly waterproofed printing and copying sheet according to the present invention comprises a sheet of colored opaque water-resisting paper having water absorbing capacity of the cob of less than 30 g/m², a colorless transparent thin film made of water-resisting heat-resisting synthetic resin which is dry-laminated on the front surface of the sheet of colored opaque paper and a colorless transparent thin film made of water-resisting heat-resisting synthetic resin which is dry-laminated on the back surface of the sheet of colored opaque paper. The perfectly waterproofed printing and copying sheet is to be used for outdoor advertisement, outdoor notification, etc.

Also, for the purpose of accomplishing the above-mentioned problems, the perfectly waterproofed printing and copying sheet according to the present invention comprises a sheet of colored opaque water-resisting paper having water absorbing capacity of the cob of less than 30 g/m², a colorless transparent thin film made of water-resisting and heat-resisting synthetic resin which is dry-laminated on the front surface of the sheet of colored opaque paper, a layer of water-resisting adhesives which is coated on the back surface of the sheet of colored opaque paper and a sheet of releasing paper releasably adhered to the layer of adhesives. The perfectly waterproofed printing and copying sheet is to be used for bar codes and labels.

In the present invention, films made of the water-resisting heat-resisting synthetic resin include all of well-known films, however, polyester synthetic resin films such as polyethylene terephthalate film having the thickness of 10 to 75 microns are preferably used. Also, the water-resisting heat-resisting synthetic resin films can be colorless and transparent, because the sheet of water-resisting paper is colored and opaque. This is useful to reduce the cost.

As to sheets of water-resisting paper, it is necessary for the sheets to be colored and opaque. Also, it is necessary for the sheets to have the thickness of 45 to 250 g/m² and high water-resisting property, namely, water absorbing capacity of the cob of less than 30 g/m² which is based on Japanese Standard, JISP8111.

As to dry-laminating, well-known adhesives such as polyurethane resin, acrylic resin, rubber, etc. which are dissolved in respective solvents are coated and pressed to form a layer, as the solvents are dried.

As to heat-resisting adhesives, well-known acrylic resin, synthetic rubber, etc. are used, and the adhesives are preferably coated at the thickness of at least 10 to 25 microns for waterproofing.

As to sheets of releasing paper, well known sheets having the thickness of 45 to 150 g/m² can be used. Also, it is preferable for the thickness of the coating layer of silicon which is coated on the releasing paper is within a range of less than 3 microns.

### BRIEF DESCRIPTION OF THE DRAWINGS

FIG. 1 is an enlarged diagram showing a section of an example of the present invention.

FIG. 2 is an enlarged diagram showing a section of another example of the present invention.

FIG. 3 is an enlarged diagram showing a section of another example of the present invention.

### DESCRIPTION OF THE PREFERRED EXAMPLES

### Example 1

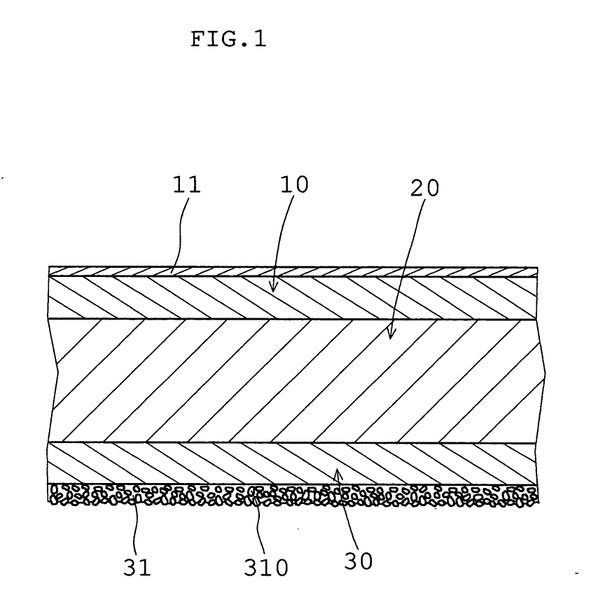

As shown in FIG. 1, the perfectly waterproofed printing and copying sheet according to Example 1 of the present invention comprised a sheet of white-colored water-resisting paper 20 having water absorbing capacity of the cob of 29 g/m² and the thickness of 104 g/m², a colorless transparent film of polyethylene terephthalate 10 having the thickness of 38 microns, which was dry-laminated on the front surface of the sheet of paper 20 with a solution of adhesives of polyurethane to which a small quantity of curing agents was added, and which had a water-resisting coating layer 11 having the thickness of 3 microns formed with a solution of unsaturated polyester resin to which a small quantity of curing agents was added, and a colorless transparent film of polyethylene terephthalate 30 having the thickness of 25 microns which was dry-laminated on the back surface of the sheet of paper in the same way as the before-mentioned, and which had a water-resisting heat-resisting coating layer 31 of unsaturated polyester resin having the thickness of 5 microns to which 20% by weight of silica 310 having an average grain size of 3 microns and well-known anti-static agents were added. Thus, the product of Example 1 capable of being printed or copied on one surface was obtained.

The product of Example 1 did not curl nor wave, when kept in the custody, and when used by means of printing or copying machines. Also, the product was not blocked in nor sent out of the printing or copying machines, as two or more than two sheets were superposed, when used by means of printing or copying machines. Also, the product did not curl nor wave, when the product was tested after being hung in a room having the humidity Of 70% for a week.

### Example 2

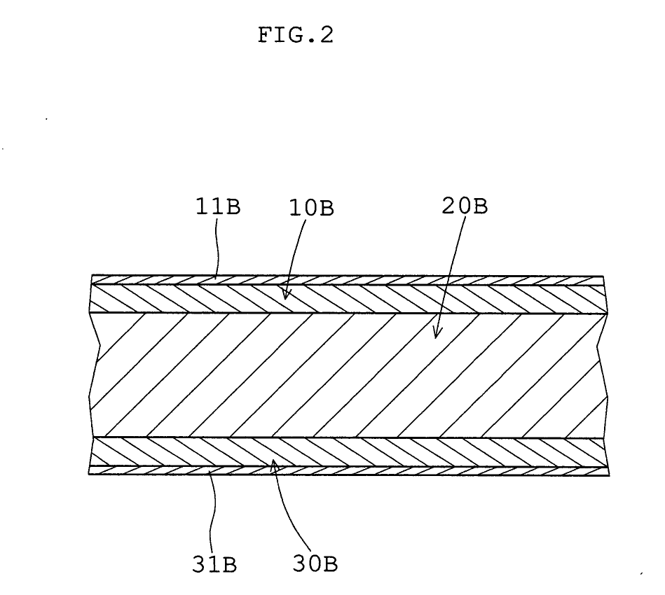

As shown in FIG. 2, the perfectly waterproofed printing and copying sheet according to Example 2 of the present invention comprised a sheet of white colored water-resisting paper 20B having water absorbing capacity of the cob of 29 g/m² and the thickness of 104 g/m², a colorless transparent film of polyethylene terephthalate 10B having the thickness of 25 microns which was dry-laminated on the front surface of the sheet of paper 20B with a solution of adhesives of polyurethane to which a small quantity of well known curing agents was added, and which had a water-resisting heat resisting coating layer 11B having the thickness of 3 microns made from a solution of unsaturated polyester resin to which a small quantity of well known anti-static agents was added, and a colorless transparent film of polyethylene terephthalate 30B having the thickness of 25 microns which was dry-laminated on the back surface of the sheet of paper 20B in the same way as the before-mentioned. Thus, the product of Example 2 capable of being printed or copied on both surfaces was obtained.

The product of Example 2 did not curl nor wave, when kept in the custody, and when used by means of printing or copying machines. Also, the product was not blocked in nor sent out of printing or copying machines, as two or more than two sheets were superposed, when used by means of the printing or copying machines. Also, the product did not curl nor wave, when the product was tested, after being hung in a room having the humidity of 70% for a week.

### Example 3

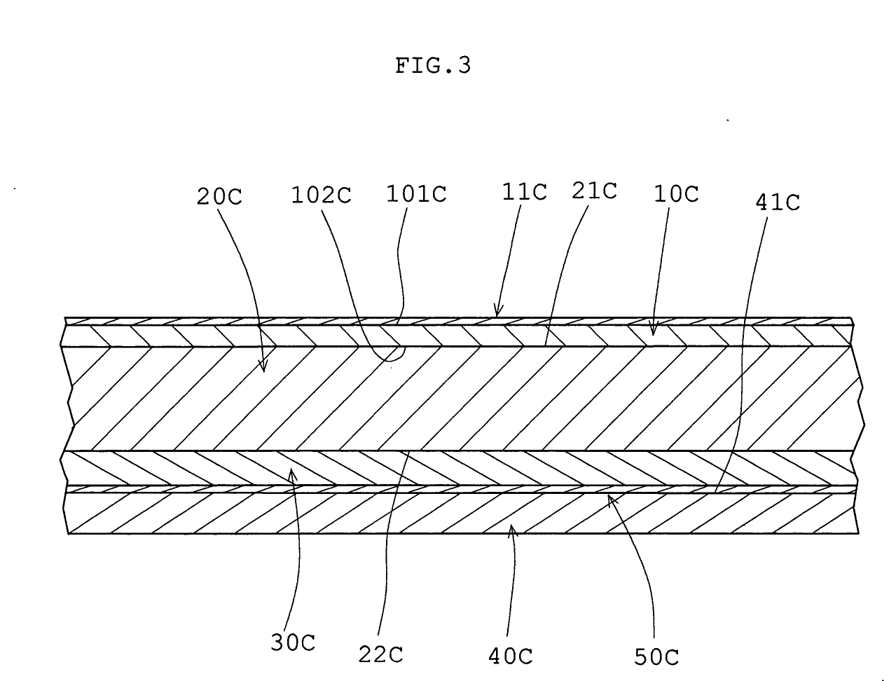

As shown in FIG. 3, the perfectly waterproofed printing and copying sheet according to Example 3 of the present invention comprised a colorless transparent thin film of water-resisting heat-resisting synthetic resin 10C, a white colored sheet of water-resisting heat-resisting paper 20C dry-laminated on the back surface of the film 10C, a layer of water-resisting adhesives 30C coated on the back surface of the sheet of paper 20C and a releasing paper 40C releasably adhered to the layer of adhesives 30C.

The film 10C was made of polyethylene terephthalate having heat-resisting property of about more than 200° C., and the film had the thickness of 12 microns. Also, on the front surface of the film 10C, a layer of water-resisting heat-resisting coating 11C for fixing toners having the thickness of 3 microns was made from a solution of unsaturated polyester resin to which a small quantity of well known anti-static agents was added.

The sheet of water-resisting paper had the thickness of 104 g/m² and water absorbing capacity of the cob of 10 g/m². Also, on the upper surface 21C of the sheet 20C, the film 10C was dry-laminated with a solution of adhesives of polyurethane to which a small quantity of curing agents was added.

The layer of water-resisting adhesives 30C was coated on the back surface of the sheet of water-resisting paper 20C with well known adhesives of water-resisting acrylic resin, and had the thickness of 20 microns.

The releasing paper 40C had the thickness of 84 g/m² and water absorbing capacity of the cob of 29 g/m², and the paper was coated with a layer of silicon 50C having the thickness of 1 micron on the front surface 41C, and was releasably adhered to the layer of adhesives 30C.

The product of Example 3 did not curl nor wave, when kept in the custody, and when used by means of printing or copying machines. Also, the product was not blocked in nor sent out of printing or copying machines, as two or more than two sheets were superposed, when used by means of the printing or copying machines.

Also, after the product was printed or copied, the releasing paper was released, and respective labels were affixed to a board. After the labels were affixed to the board, the labels were sprayed with water for a minute and left as they were for three hours, after the labels were sprayed with water for a minute. However, the labels did not release from the board.

### Advantages

The perfectly waterproofed printing and copying sheet according to the present invention suitable for outdoor advertisements, outdoor notifications, etc. comprises a sheet of paper which has front and back surfaces dry-laminated with respective thin films made of high degree water-resisting heat-resisting synthetic resin, and the sheet of paper used has high degree water-resisting property. Accordingly, the perfectly waterproofed printing and copying sheet can perfectly prevent water and moisture from penetrating into the sheet from sides owing to the thickness of the sheet, and can be prevented from curling and waving, when kept in the custody, and when used by means of printing or copying machines.

Also, the perfectly waterproofed printing and copying sheet according to the present invention suitable for bar codes and labels for seafood, which is moist and watery, comprises a sheet of paper which has a front surface dry-laminated with a film made of high degree water-resisting heat-resisting synthetic resin and a back surface coated with water-resisting adhesives. Also, the sheet of paper has high degree water-resisting property. Accordingly, the perfectly waterproofed printing and copying sheet can perfectly prevent water and moisture from penetrating into the sheet from sides owing to the thickness of the sheet, and can be prevented from curling and waving, when kept in the custody, and when used by means of printing or copying machines.

Furthermore, because of the perfectly waterproofed printing and copying sheet according to the present invention comprising a colorless transparent thin film made of high degree water-resisting heat-resisting synthetic resin, the cost of the printing and copying sheet can be sharply reduced.

I claim:

1. A perfectly waterproofed printing and copying sheet suitable for outdoor advertisements, outdoor notifications, etc. comprising a sheet of colored opaque paper having water absorbing capacity of the cob of less than 30 g/m², a colorless transparent film of water-resisting heat-resisting synthetic resin which is dry-laminated on the front surface of the sheet of paper and a colorless transparent thin film of water-resisting heat-resisting synthetic resin which is dry-laminated on the back surface of the sheet of paper.

2. A perfectly waterproofed printing and copying sheet suitable for bar codes and labels comprising a sheet of colored opaque paper having water absorbing capacity of the cob of less than 30 g/m², a colorless transparent thin film of water-resisting heat-resisting synthetic resin which is dry-laminated on the front surface of the sheet of paper, a layer of adhesives coated on the back surface of the sheet of paper and a releasing paper releasably affixed to the surface of the layer of adhesives.
